(19) United States
(12) Patent Application Publication
(10) Pub. No.: US 2007/0229905 A1
(43) Pub. Date: Oct. 4, 2007

(54) Plate making/printing system and plate inspection method for use in same

(75) Inventors: Itaru Furukawa, Kyoto (JP); Kenta Nagai, Kyoto (JP)

Correspondence Address: MCDERMOTT WILL & EMERY LLP, 600 13TH STREET, N.W., WASHINGTON, DC, 20005-3096, US

(73) Assignee: DAINIPPON SCREEN MFG, CO., LTD

(21) Appl. No.: 11/723,800

(22) Filed: Mar. 22, 2007

(30) Foreign Application Priority Data
Mar. 28, 2006 (JP) P2006-089142

(51) Int. Cl. G06K 15/00

(52) U.S. Cl. 358/1.18

(57) ABSTRACT

A hash value generation section at a plate making site, which is a first site, generates a hash value based on edit layout data. A reference image data output section outputs reference image data to a folder named after the hash value. The reference image data is transmitted from the plate making site to a press plate site, which is a second site, while being kept contained in the folder. A hash value generation section at the press plate site generates a hash value based on the edit layout data transmitted from the plate making site. Based on the hash value, a plate inspection process section retrieves a folder containing reference image data that is to be used for a plate inspection process.

### BACKGROUND OF THE INVENTION

1. Field of the Invention

The present invention relates to plate making/printing systems, and more specifically to a plate inspection method for use in a plate making/printing system in which a plate making process and a press plate output process are operated at different sites.

2. Description of the Background Art

With the advance of digitization in the field of printing and plate making, recent years have seen the spread of so-called “CTP (Computer To Plate)” technology, which allows digital data on a computer to be directly outputted onto press plates without involving films. In a plate making/printing system, a plate making process mainly involving design of prints is performed at an upstream stage, and a press plate output process mainly involving production of plates (press plates) that are to be placed in a printing machine is performed at a downstream stage. In the CTP technology, necessary data is transmitted in digital format from the upstream stage to the downstream stage.

In such a plate making/printing system, it is often the case that the plate making process and the press plate output process are performed, for example, at different companies. Such an operation is referred to as, for example, the “two-site operation”, and data generated at the upstream stage (hereinafter, referred to as the “first site”) is transmitted online or offline to the downstream stage (hereinafter, referred to as the “second site”). In the two-site operation system, the operation is generally carried out in the following manner. At the first site, page data written in a page-description language is generated first, and an imposition process is performed based on the page data. Thereafter, a RIP process is performed on data obtained by the imposition process, and an output result is confirmed in a proof. Transmitted from the first site to the second site is the data that has been obtained by the imposition process but not subjected to the RIP process (hereinafter, referred to as “edit layout data”). The reason why the data that has not been subjected to the RIP process is transmitted is that, before image data that is to be used for outputting a press plate is generated at the second site, processes including a so-called pasteup process for setting a layout that is to be used when outputting the press plate are performed. Thereafter, at the second site, the RIP process is performed on the edit layout data subjected to the pasteup process, etc. As a result, the image data that is to be used for outputting the press plate is generated. Note that in some systems, the imposition process may be performed at the second site.

By the way, in the plate making/printing system employing the two-site operation as described above, the output result obtained at the first site and the output result obtained at the second site are not always consistent with each other. This is conceivably caused by, for example, differences between the two sites in versions of operating systems or applications on computers, fonts, etc., and an error made by an operator during the imposition process or the pasteup process. In addition, if data that is to be used for outputting a press plate is erroneous, considerable cost and time might be required to correct the error. Therefore, importance is placed on a plate inspection process for checking whether the output result obtained at the first site and the output result obtained at the second site are consistent with each other. In order to perform the plate inspection process using a computer, it is necessary to transmit image data obtained by the RIP process at the first site to the second site. That is, in addition to the data before the RIP process (the edit layout data), data after the RIP process (hereinafter, referred to as “reference image data”) must be transmitted from the first site to the second site.

In the data transmission from the first site to the second site, it is necessary to correlate the edit layout data with the reference image data in some fashion in order to perform the plate inspection process at the second site. A conceivable correlation approach is to, for example, generate an administrative file for storing information (data) that indicates the correlation between the edit layout data and the reference image data, and transmit the administrative file from the first site to the second site. Other conceivable approaches include embedding a link to the reference image data into the edit layout data outputted at the first site, and correlating these pieces of data by using file names.

Note that Japanese Laid-Open Patent Publications Nos. 2000-272078 and 2004-148734 disclose conventional plate inspection methods for use in printing/plate making systems.

In the case of correlating the edit layout data with the reference image data by the administrative file, however, it is necessary to establish the format of the administrative file. It is often the case that the format of files used in a computer system is changed by, for example, upgrading application software. Therefore, it is envisaged that, for example, when there is a difference in versions of application software used at the first site and the second site, the administrative file might not be properly read at the second site. In addition, there are possible problems such as overlapping of identification numbers (IDs) that are used, for example, to identify files, and loss of the administrative file due to an error by an operator. Furthermore, as for the approach that embeds a link to the reference image data into the edit layout data outputted at the first site, it is conceivable that various modifications, such as modification to application software for the pasteup process, might be required. Also, as for the approach that uses file names, in the case where the same file names are used or the same file is outputted a plurality of number of times, there arises a problem with data consistency.

### SUMMARY OF THE INVENTION

Therefore, an object of the present invention is to provide a plate making/printing system employing the two-site operation and capable of reliably performing a plate inspection process by ensuring that data required for the plate inspection process is transmitted from the first site to the second site.

The present invention has the following features to attain the above object.

A first aspect of the present invention is directed to a plate making/printing system including: a first system for generating edit data containing one or more pieces of page data written in a page-description language and first image data obtained by converting the edit data to a bitmap format; and a second system for generating second image data obtained by converting the edit data generated in the first system for use in production of a press plate to the bitmap format, the first system including: a first unique code generation section for generating a unique code specific to contents of the edit data in accordance with a predetermined rule; and a first image data output section for outputting the first image data in association with the code generated by the first unique code generation section, the second system including: a second unique code generation section for generating a unique code specific to the contents of the edit data generated in the first system in accordance with the predetermined rule; and a plate inspection section for performing plate inspection by comparing the first image data generated in the first system with the second image data, the plate inspection section identifying a first image data that is to be compared with the second image data based on the code generated by the second unique code generation section.

With this configuration, in the first system, the first image data, which is obtained by converting the edit data to the bitmap format, is outputted in association with a unique code generated based on the edit data in accordance with a predetermined rule. On the other hand, in the second system, the plate inspection section identifies a first image data that is to be compared to the second image data for use in production of a press plate based on a unique code generated based on the edit data in accordance with the same rule as the rule used in the first system. Accordingly, by providing the first image data generated in the first system to the second system, while keeping the first image data associated with the unique code, a first image data that is to be compared with second image data targeted for inspection can be readily and reliably identified in the second system. Thus, it is ensured that at the time of a plate inspection process, the data targeted for inspection is correlated with data that is to be compared therewith, whereby it is made possible to prevent the plate inspection process from being performed based on erroneous data, as well as to perform the plate inspection process expeditiously.

In the thus-configured plate making/printing system, it is preferred that the first unique code generation section further generates a unique code specific to the contents of each piece of page data contained in the edit data, and the second unique code generation section further generates a unique code specific to the contents of each piece of page data contained in the edit data generated in the first system.

With this configuration, the edit data and the first image data are correlated not only on a one-to-one basis but also on a page data basis. Therefore, in the second system, it is possible to perform the plate inspection process on the second image data not only on an edit data basis but also on a page data basis.

In the thus-configured plate making/printing system, it is preferred that the code generated by the first unique code generation section and the code generated by the second unique code generation section are hash values.

With this configuration, the edit data and the first image data are correlated by a hash value generated based on the contents of the edit data in accordance with a predetermined rule. For example, by generating a hash value based on a script written in the header of the edit data, it is possible to make the hash value unique to the contents of the edit data. Accordingly, it is ensured that the edit data and the first image data are correlated by a unique value. Thus, it is possible to prevent an unsuccessful correlation from being caused by a program related to data correlation or operator error. In addition, by generating the hash value in the above manner, the hash value becomes specific to the contents of the edit data, whereby it is made possible to prevent values from overlapping between different pieces of data, as well as to prevent the plate inspection process from being performed based on erroneous data.

In the thus-configured plate making/printing system, it is preferred that the second system further includes a first image data holding portion for holding the first image data generated in the first system, and the plate inspection section identifies a first image data that is to be compared with the second image data from among the first image data held in the first image data holding portion.

With this configuration, locations for holding the first image data are prepared in the second system. Therefore, even when data transmission from the first system to the second system is manually performed, it is only necessary for the operator to store the first image data to a predetermined location in the second system. Thus, it is possible to readily carry out system operation, and suppress occurrence of any operational error.

Another aspect of the present invention is directed to a plate inspection method for use in a plate making/printing system including a first system for generating edit data containing one or more pieces of page data written in a page-description language and first image data obtained by converting the edit data to a bitmap format and a second system for generating second image data obtained by converting the edit data generated in the first system for use in production of a press plate to the bitmap format, the method comprising: a first unique code generation step performed in the first system for generating a unique code specific to contents of the edit data in accordance with a predetermined rule; a first image data output step performed in the first system for outputting the first image data in association with the code generated in the first unique code generation step; a second unique code generation step performed in the second system for generating a unique code specific to the contents of the edit data generated in the first system in accordance with the predetermined rule; and a plate inspection step performed in the second system for performing plate inspection by comparing the first image data generated in the first system with the second image data, in the plate inspection step a first image data that is to be compared with the second image data being identified based on the code generated by the second unique code generation step.

These and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a block diagram illustrating the overall configuration of a plate making/printing system according to an embodiment of the present invention.

FIG. 2 is a diagram schematically illustrating data and flows thereof in the embodiment.

FIG. 3 is a diagram schematically illustrating data storage locations within a design device and a plate inspection device in the embodiment.

FIG. 4 is a functional block diagram illustrating a detailed configuration of the plate making/printing system according to the embodiment.

FIG. 5 is a flowchart illustrating a process procedure performed at a plate making site by the design device in the embodiment.

FIG. 6 is a flowchart illustrating a process procedure performed at a press plate layout site by a press plate layout data generation device in the embodiment.

FIG. 7 is a flowchart illustrating a process procedure performed at the press plate output site by a plate inspection device in the embodiment.

FIG. 8 is a diagram for explaining the operation for a plate inspection process in the embodiment.

FIG. 9 is a diagram schematically illustrating data storage locations within a design device and a plate inspection device in a variant of the embodiment.

FIG. 10 is a diagram illustrating a configuration of page hash value data in the variant.

FIG. 11 is a diagram for explaining the operation for the plate inspection process in the variant.

### DETAILED DESCRIPTION OF THE PREFERRED EMBODIMENTS

Hereinafter, an embodiment of the present invention will be described with reference to the accompanying drawings.

<1. Overall Configuration>

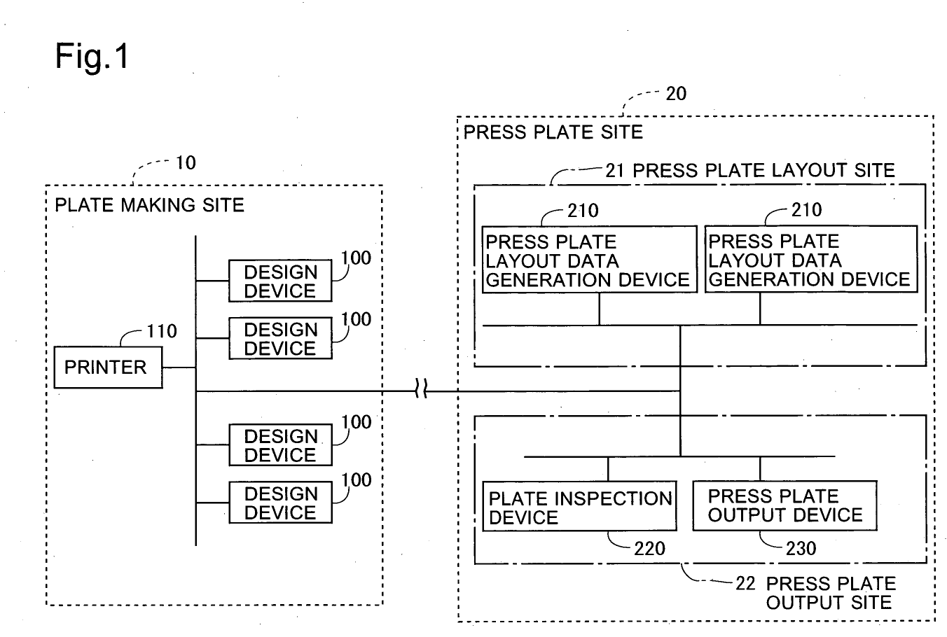

FIG. 1 is a block diagram illustrating the overall configuration of a plate making/printing system according to an embodiment of the present invention. The plate making/printing system includes a plate making site 10 constituting a first system for designing prints and a press plate site 20 constituting a second system for producing plates (press plates) that are to be placed in a printing machine. In this manner, the present embodiment employs a so-called “two-site operation” in which a plate making process and a press plate output process are performed at different sites (sections). The plate making site 10 includes design devices 100 implemented by personal computers or the like, and a printer 110. The press plate site 20 is composed of a press plate layout site 21 and a press plate output site 22. The press plate layout site 21 includes press plate layout data generation devices 210 implemented by personal computers or the like. The press plate output site 22 includes a plate inspection device 220 implemented by a personal computer or the like, and a press plate output device 230 implemented by a device known as a “CTP” device or the like. In this system, data outputted from the plate making site 10 is inputted to the press plate site 20, and data transmission from the plate making site 10 to the press plate site 20 is performed either offline via a recording medium or online via a network.

Next, the operation of each component shown in FIG. 1 is described. The design device 100 generates page data, which contains a print target written in a page-description language, by performing an edit process using characters contained in a print and a plurality of types of other elements of the print, e.g., logos, patterns and illustrations. In addition, the design device 100 performs an imposition process to, for example, paste page data for four pages onto one sheet, and outputs edit layout data. Furthermore, the design device 100 outputs reference image data as first image data, which is obtained by performing a RIP process on the edit layout data, for a plate inspection process at the press plate site 20. The printer 110 outputs a proof (a test copy) as a product of the RIP process in the design device 100.

Upon receipt of the edit layout data transmitted from the plate making site 10, the press plate layout data generation device 210 performs a pasteup process for setting a layout of the data, which is used when outputting a press plate, and outputs press plate layout data (press plate position data) as a resultant product. The plate inspection device 220 receives the edit layout data transmitted from the plate making site 10 and the press plate layout data outputted from the press plate layout data generation device 210, performs a RIP process on theses pieces of data, and outputs image data that is to be used for outputting a press plate. At this time, the plate inspection device 220 reads the reference image data transmitted from the plate making site 10, and performs a process (a plate inspection process) for comparing the reference image data with plate inspection data (hereinafter, referred to as “target image data”), which is second image data obtained by the RIP process at the press plate site 20. The press plate output device 230 receives the image data, that is to be used for outputting the press plate, from the plate inspection device 220, and outputs a press plate.

<2. Data Flows>

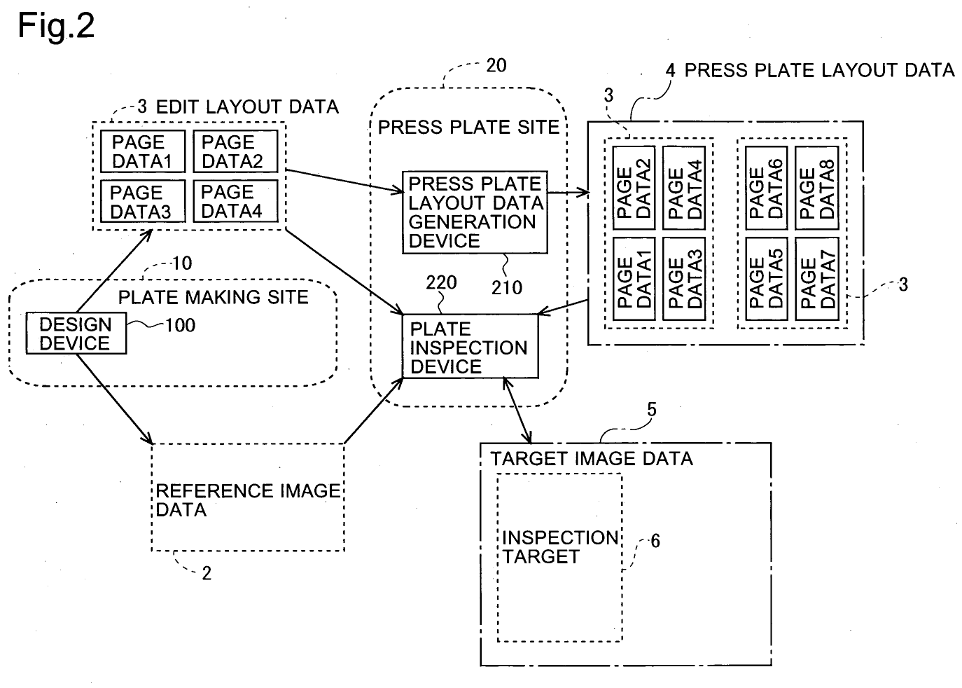

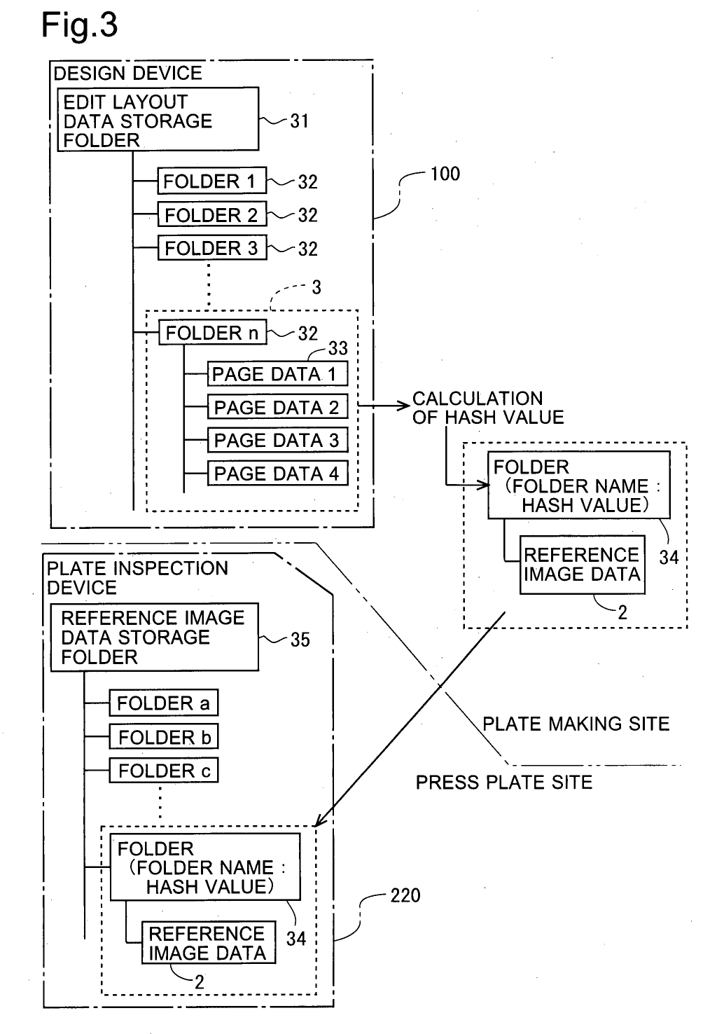

Referring to FIGS. 2 and 3, data generated in the system and data flows after the edit process at the plate making site 10 but before the plate inspection process at the press plate site 20 are described next. FIG. 2 is a diagram schematically illustrating the data generated in the system and flows thereof. FIG. 3 is a diagram schematically illustrating data storage locations within the design device 100 and the plate inspection device 220.

At the plate making site 10, edit layout data 3 and reference image data 2 are outputted from the design device 100 as shown in FIG. 2. The edit layout data 3 is data obtained by performing an imposition process and containing page data for a plurality of pages. In addition, the edit layout data 3 has not been subjected to a RIP process, and contains character data and element data concerning illustrations and the like. On the other hand, the reference image data 2 is data subjected to the RIP process, i.e., raster data (bitmap data).

The design device 100 includes an edit layout data storage folder 31 for storing the edit layout data 3 as shown in FIG. 3. The edit layout data 3 generated in the design device 100 is outputted to the edit layout data storage folder 31. In the present embodiment, the edit layout data 3 includes page data 33 for a plurality of pages and information (data) concerning imposition, and is contained in a single folder 32. The reference image data 2 is outputted to a folder 34, which is a data storage portion named after a hash value calculated based on a script written in the header of the edit layout data 3. As such, in the present embodiment, the edit layout data 3 and the reference image data 2 are correlated by a hash value. The edit layout data 3 and the reference image data 2 are transmitted offline or online from the plate making site 10 to the press plate site 20.

As shown in FIG. 3, the plate inspection device 220 includes a reference image data storage folder 35, which is a first image data holding portion for storing the reference image data 2 transmitted from the plate making site 10. The reference image data 2 transmitted from the plate making site 10 is stored to the reference image data storage folder 35, while being kept contained in the folder 34 named after the hash value.

At the press plate site 20, the press plate layout data generation device 210 receives the edit layout data 3 as shown in FIG. 2. In the press plate layout data generation device 210, a pasteup process is performed based on the edit layout data 3. For example, two pieces of edit layout data 3 are laid out onto a single press plate as shown in FIG. 2. After the pasteup process is performed in this manner, press plate layout data 4 is outputted from the press plate layout data generation device 210. The press plate layout data 4 is information (data) indicating a layout (positions) of edit layout data pieces on the press plate. That is, character data and element data concerning illustrations and the like are not contained in the press plate layout data 4 itself. Accordingly, image data that is to be used for outputting the press plate can be generated based on both the press plate layout data 4 and the edit layout data 3.

At the press plate site 20, after the press plate layout data 4 is outputted from the press plate layout data generation device 210, the plate inspection device 220 receives the edit layout data 3 and the press plate layout data 4. The plate inspection device 220 generates target image data 5 for a plate inspection process based on the edit layout data 3 and the press plate layout data 4. The target image data 5 is data subjected to a RIP process, i.e., raster data (bitmap data). Thereafter, the plate inspection device 220 compares data 6, which is a portion of the target image data 5 that is targeted for inspection, with the reference image data 2 stored in the reference image data storage folder 35.

<3. Detailed Configuration of the Plate Making/Printing System>

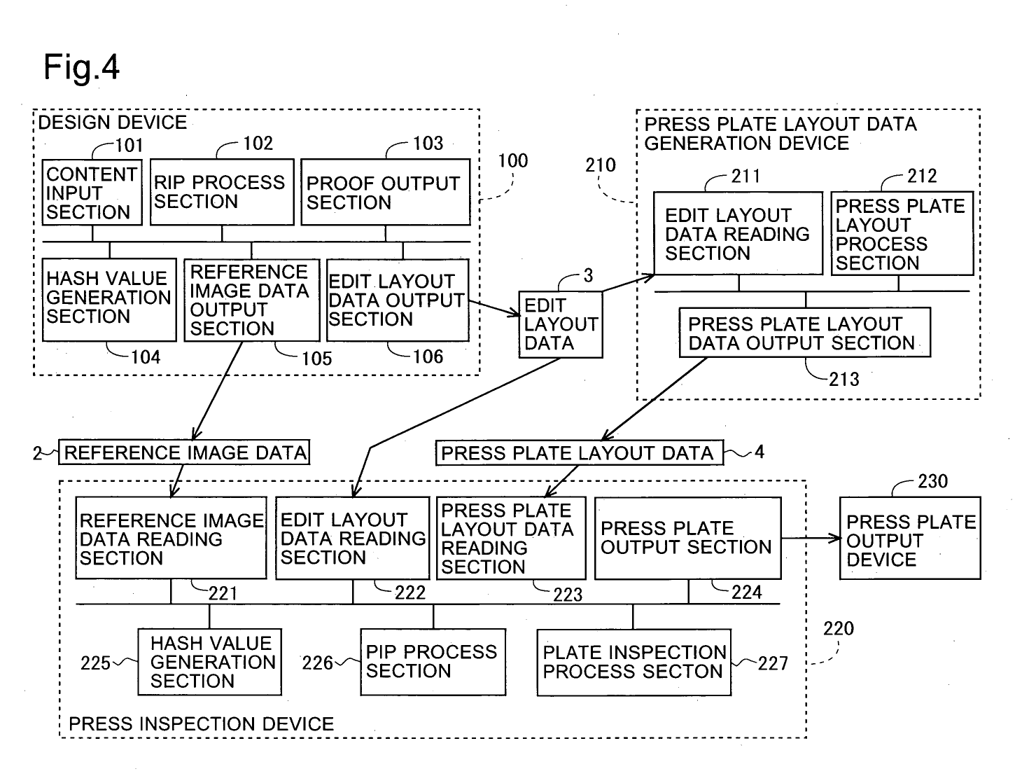

FIG. 4 is a functional block diagram illustrating a detailed configuration of the plate making/printing system according to the present embodiment. The design device 100 includes a content input section 101, a RIP process section 102, a proof output section 103, a hash value generation section 104, which acts as a first unique code generation section, a reference image data output section 105, and an edit layout data output section 106, which acts as a first image data output section. The content input section 101 generates page data, which contains character data and element data concerning illustrations and the like, and performs an imposition process based on the page data. The RIP process section 102 performs a RIP process on page data obtained by the imposition process. The proof output section 103 outputs image data generated by the RIP process to the printer 110 as a proof. The hash value generation section 104 calculates a hash value based on a script written in the header of the page data obtained by the imposition process. The reference image data output section 105 outputs the image data generated by the RIP process as reference image data 2 to a folder named after the hash value calculated by the hash value generation section 104. The edit layout data output section 106 outputs edit layout data 3 based on the page data obtained by the imposition process.

The press plate layout data generation device 210 includes an edit layout data reading section 211, a press plate layout process section 212, which acts as a press plate layout section, and a press plate layout data output section 213. The edit layout data reading section 211 reads the edit layout data 3 transmitted from the plate making site 10. The press plate layout process section 212 performs a pasteup process based on the edit layout data 3. The press plate layout data output section 213 outputs press plate layout data 4 as a product of the pasteup process.

The plate inspection device 220 includes a reference image data reading section 221, an edit layout data reading section 222, a press plate layout data reading section 223, a press plate output section 224, a hash value generation section 225, which acts as a second unique code generation section, a RIP process section 226, and a plate inspection process section 227, which acts as a plate inspection section. The reference image data reading section 221 reads the reference image data 2, which has been transmitted from the plate making site 10 and stored in the reference image data storage folder 35. The edit layout data reading section 222 reads the edit layout data 3 transmitted from the plate making site 10. The press plate layout data reading section 223 reads the press plate layout data 4 outputted from the press plate layout data generation device 210. The hash value generation section 225 calculates a hash value based on a script written in the header of the edit layout data 3. The RIP process section 226 performs a RIP process on the edit layout data 3 based on the press plate layout data 4, thereby generating image data that is to be used for outputting a press plate as well as target image data 5 for a plate inspection process. The plate inspection process section 227 compares data 6, which is a portion of the target image data 5 that is targeted for inspection, with the reference image data 2. The press plate output section 224 outputs the image data that is to be used for outputting a press plate to the press plate output device 230.

<4. Process Flows>

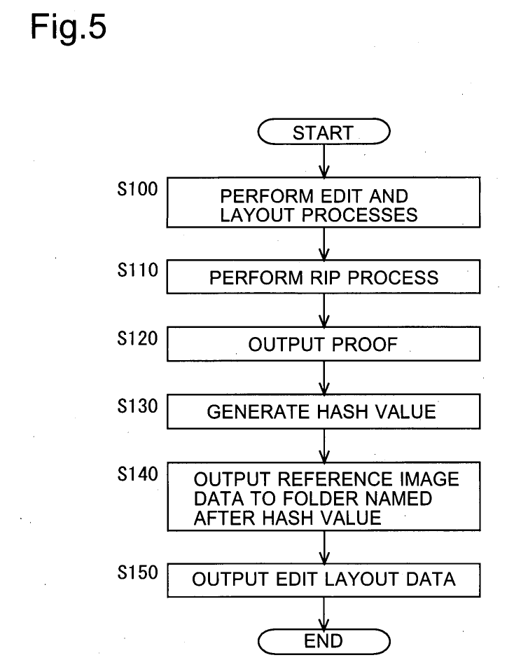

Next, process procedures in the present embodiment are described. FIG. 5 is a flowchart illustrating a process procedure performed at the plate making site 10 by the design device 100. In step S100, the content input section 101 performs an edit process based on character data and element data concerning illustrations and the like, and also performs other processes including an imposition process of page data generated by the edit process. In step S110, the RIP process section 102 performs a RIP process on page data obtained by the imposition process. In step S120, the proof output section 103 outputs image data generated by the RIP process to the printer 110 as a proof. In step S130, the hash value generation section 104 calculates a hash value based on the page data obtained by the imposition process.

In step S140, the reference image data output section 105 outputs the image data generated by the RIP process as reference image data 2. At this time, a folder 34 named after the hash value calculated in step S130 is first created in the design device 100. Then, the reference image data 2 is stored into the created folder 34. In step S150, the edit layout data output section 106 outputs edit layout data 3 based on page data obtained by the imposition process.

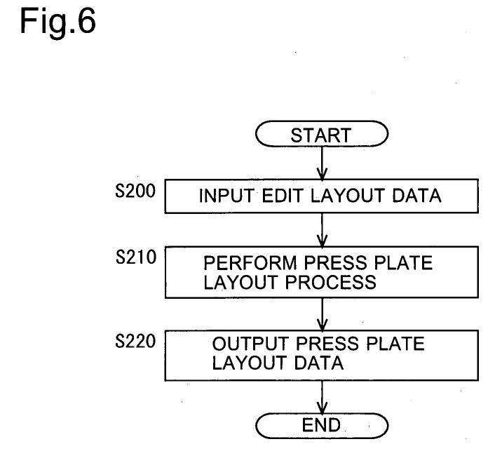

FIG. 6 is a flowchart illustrating a process procedure performed at the press plate layout site 21 by the press plate layout data generation device 210. In step S200, the edit layout data reading section 211 reads edit layout data 3. In step S210, the press plate layout process section 212 performs a pasteup process based on the edit layout data 3. In step S220, the press plate layout data output section 213 outputs press plate layout data 4 as a product of the pasteup process.

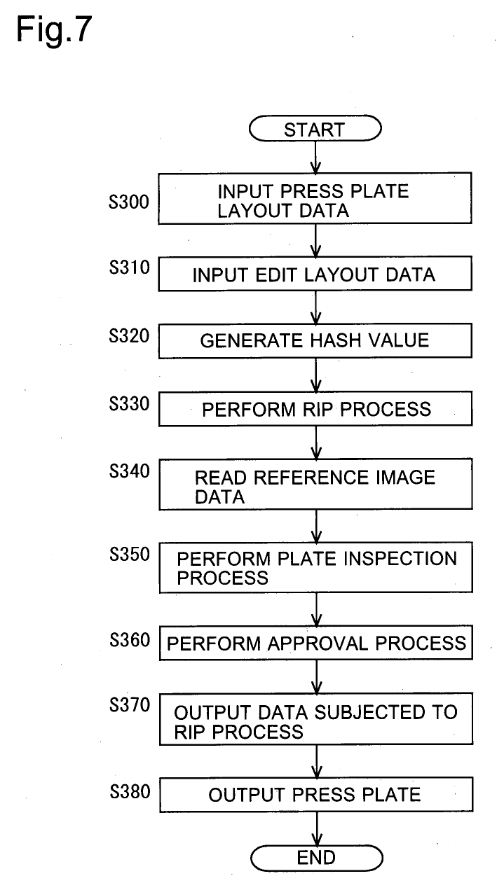

FIG. 7 is a flowchart illustrating a process procedure performed at the press plate output site 22 by the plate inspection device 220. In step S300, the press plate layout data reading section 223 reads press plate layout data 4. In step S310, the edit layout data reading section 222 reads edit layout data 3 based on the press plate layout data 4. In step S320, the hash value generation section 225 calculates a hash value based on the edit layout data 3. In step S330, the RIP process section 226 performs a RIP process on the edit layout data 3 based on the press plate layout data 4. By the RIP process, target image data 5 that is to be targeted for a plate inspection process is generated.

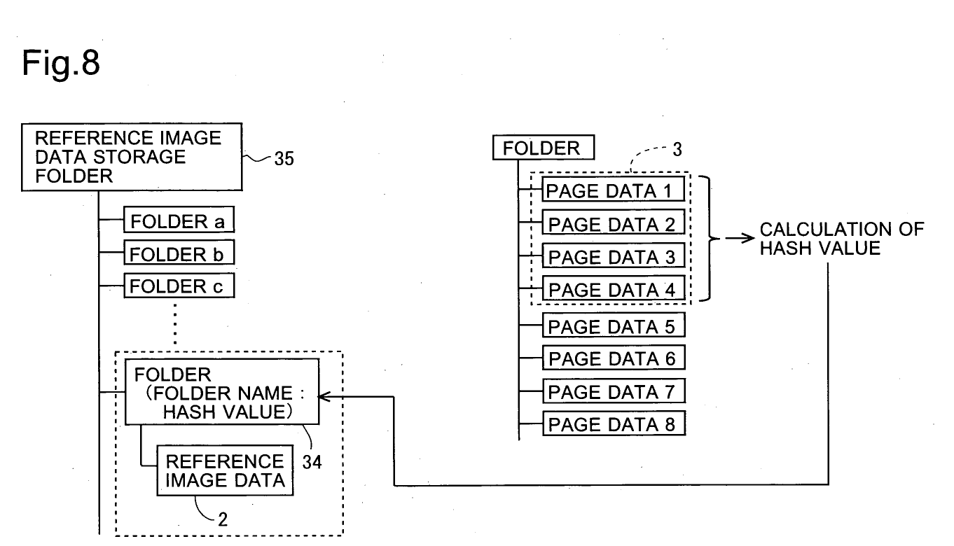

In step S340, the reference image data reading section 221 reads reference image data 2 from the reference image data storage folder 35. At this time, based on the hash value calculated in step S320, a folder named after the hash value is retrieved from among a plurality of folders stored in the reference image data storage folder 35 as shown in FIG. 8. Then, reference image data 2 is read from the retrieved folder 34. In step S350, a plate inspection process is performed, i.e., the reference image data 2 is compared with data 6, which is a portion of the target image data 5 that is to be targeted for inspection. In step S360, a process for approving the result of the plate inspection process is performed. In step S370, image data that is to be used for outputting a press plate, which has been generated by the RIP process, is outputted to the press plate output device 230. In step S380, the press plate output device 230 outputs the press plate.

<5. Advantageous Effect>

According to the present embodiment, at the plate making site 10, reference image data 2 is stored to a folder named after a hash value calculated based on edit layout data 3 as described above. Accordingly, at the plate making site 10, the edit layout data 3 and the reference image data 2 are correlated by the value uniquely determined based on data contents. The reference image data 2 is transmitted from the plate making site 10 to the press plate site 20, while being kept contained in the folder named after the hash value, and the reference image data 2 kept contained in the folder is stored to the reference image data storage folder 35 in the plate inspection device 200. Therefore, even if the edit layout data 3 and the reference image data 2 are separately transmitted from the plate making site 10 to the press plate site 20, or even if any intervening processes, such as a pasteup process using the edit layout data 3, are performed, a hash value may be calculated based on the edit layout data 3 to find a folder named after the hash value at the press plate site 20. This makes it possible to readily identify the reference image data 2 correlated with the edit layout data 3 at the press plate site 20. As a result, it is ensured that, at the time of a plate inspection process at the press plate site 20, data targeted for inspection is correlated with data that is to be compared therewith.

In addition, the edit layout data 3 and the reference image data 2 are correlated by the hash value as described above. Accordingly, an unsuccessful correlation of the edit layout data 3 and the reference image data 2 can be prevented from being caused by a program related to data correlation or operator error. Furthermore, values (for data correlation) can be prevented from overlapping between different pieces of data, and any problem that might require, for example, format change can be eliminated. As such, the edit layout data 3 and the reference image data 2 are correlated together without complicating the entire system, and therefore even if any abnormality occurs, it is possible to readily and quickly find out the cause of the abnormality. Thus, the plate inspection process is performed efficiently, and any unnecessary output of press plates is suppressed.

<6. Variant>

Described next is a variant of the above embodiment. In the above embodiment, a hash value is calculated based on data after an imposition process, i.e., edit layout data 3 containing page data for a plurality of pages, whereas in the present variant, in addition to the hash value as described above, another hash value is calculated for each piece of page data that corresponds to one page.

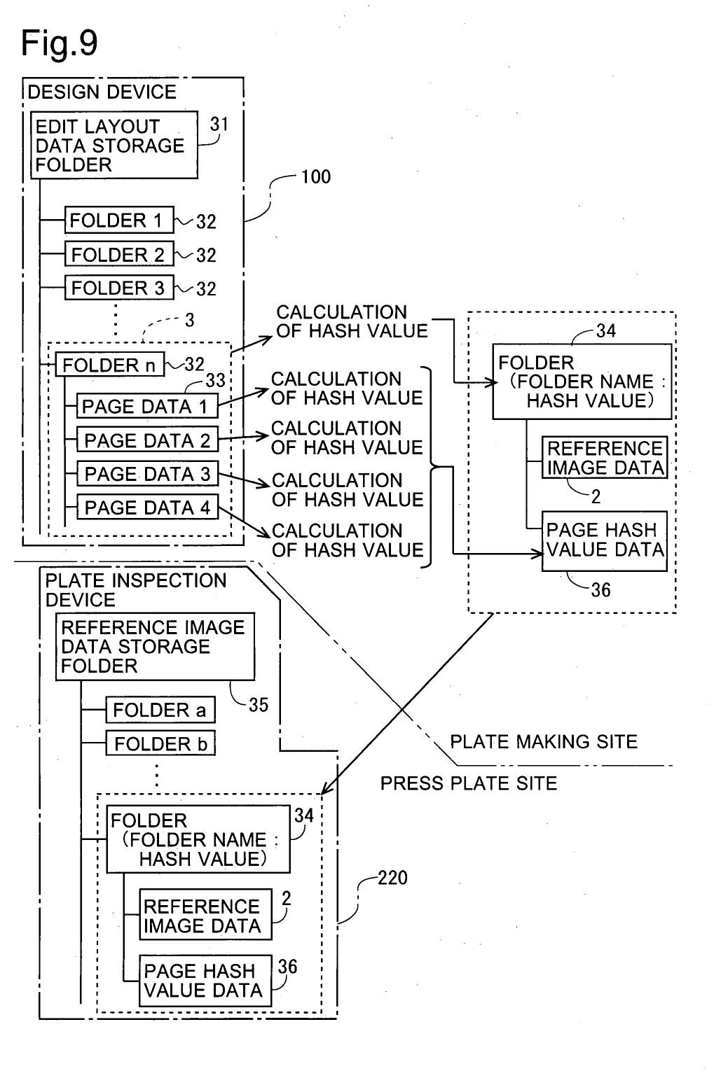

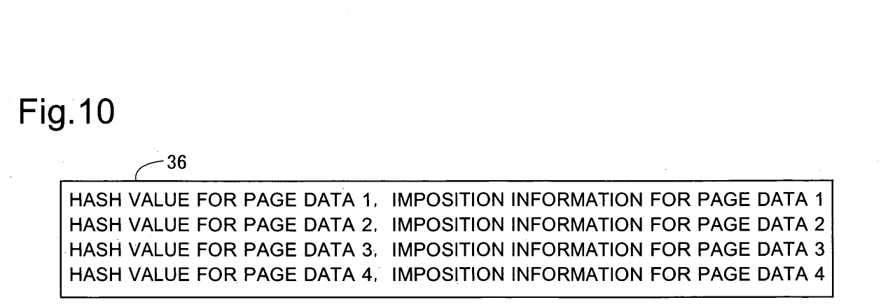

FIG. 9 is a diagram schematically illustrating data storage locations in the present variant. In the present variant, for each of plural pieces of page data 33 contained in edit layout data 3, a hash value is calculated, as shown in FIG. 9, based on a script written in the header of that piece of page data corresponding to one page. Data 36 (hereinafter, referred to as “page hash value data”), which correlates the hash value and imposition information for each piece of page data, is outputted to a folder 34 along with reference image data 2. Note that as in the above embodiment, the folder 34 shown in FIG. 9 is named after a hash value calculated based on the edit layout data 3 containing the plural pieces of page data 33. In addition, the page hash value data 36 is configured, for example, as shown in FIG. 10, but any configuration may be employed so long as the positions (layout) of the plural pieces of page data in the edit layout data 3 can be identified.

In the present variant, the page hash value data 36 and the reference image data 2 are transmitted from the plate making site 10 to the press plate site 20, while being kept contained in the folder 34. Then, at the press plate site 20, the folder 34 containing the page hash value data 36 and the reference image data 2 is stored to the reference image data storage folder 35 in the plate inspection device 220.

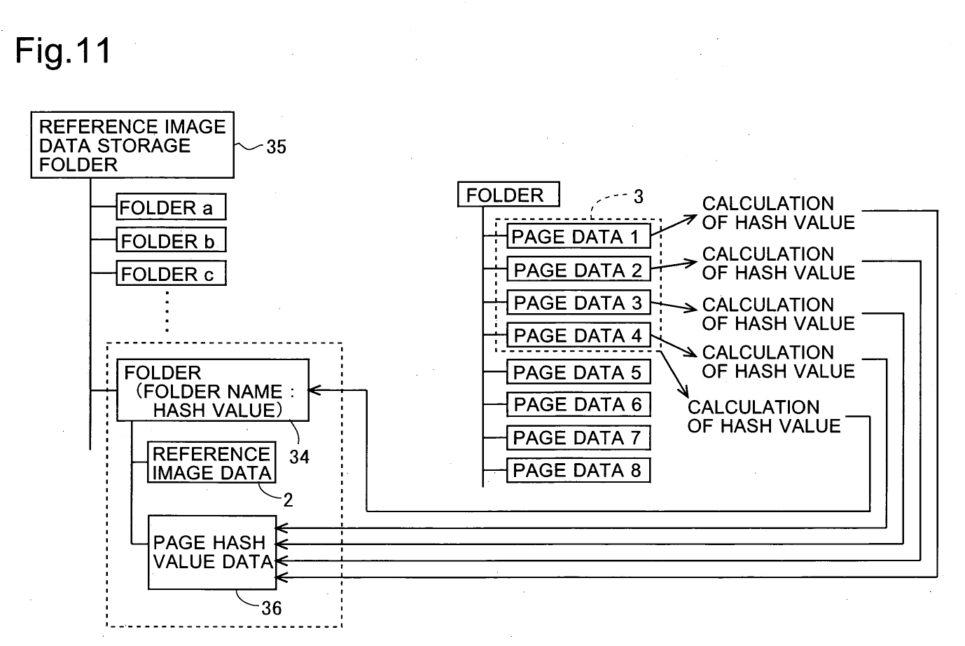

At the time of a plate inspection process, a hash value based on the edit layout data 3 and hash values, each based on a piece of page data, are calculated as shown in FIG. 11. The hash value calculated based on the edit layout data 3 is used first to retrieve the folder 34 containing the reference image data 2 from the reference image data storage folder 35. Then, the hash values, each calculated based on a piece of page data, are used as keys to refer to the page hash value data 36 in the folder 34. As a result, information concerning a position in the reference image data 2 is acquired for each piece of page data contained in the edit layout data 3. Thus, it is possible for the plate inspection device 220 to perform a plate inspection process for each piece of page data that corresponds to one page.

<7. Others>

While the above embodiment is described on the assumption that the imposition process is performed at the plate making site 10, the present invention is not limited to this. The imposition process may be performed, for example, at the press plate layout site 21 within the press plate site 20.

Furthermore, in the above embodiment, data correlation is performed based on a hash value, but the present invention is not limited to this. The data correlation may be performed based on a code other than the hash value so long as the code can be uniquely generated within the system based on data contents.

While the invention has been described in detail, the foregoing description is in all aspects illustrative and not restrictive. It is understood that numerous other modifications and variations can be devised without departing from the scope of the invention.

Note that the present application claims priority to Japanese Patent Application No. 2006-89142, titled “PLATE MAKING/PRINTING SYSTEM AND PLATE INSPECTION METHOD FOR USE IN SAME”, filed on Mar. 28, 2006, which is incorporated herein by reference.

What is claimed is:

1. A plate making/printing system comprising:
a first system for generating edit data containing one or more pieces of page data written in a page-description language and first image data obtained by converting the edit data to a bitmap format; and
a second system for generating second image data obtained by converting the edit data generated in the first system for use in production of a press plate to the bitmap format,
wherein the first system includes:
a first unique code generation section for generating a unique code specific to contents of the edit data in accordance with a predetermined rule; and
a first image data output section for outputting the first image data in association with the code generated by the first unique code generation section,
wherein the second system includes:
a second unique code generation section for generating a unique code specific to the contents of the edit data generated in the first system in accordance with the predetermined rule; and
a plate inspection section for performing plate inspection by comparing the first image data generated in the first system with the second image data, and
wherein the plate inspection section identifies a first image data that is to be compared with the second image data based on the code generated by the second unique code generation section.

2. The plate making/printing system according to claim 1,
wherein the first unique code generation section further generates a unique code specific to contents of each piece of page data contained in the edit data, and
wherein the second unique code generation section further generates a unique code specific to contents of each piece of page data contained in the edit data generated in the first system.

3. The plate making/printing system according to claim 1,
wherein the first unique code generation section generates a unique code specific to contents of each piece of page data contained in the edit data, in place of the unique code specific to the contents of the edit data, and
wherein the second unique code generation section generates a unique code specific to contents of each piece of page data contained in the edit data generated in the first system, in place of the unique code specific to the contents of the edit data generated in the first system.

4. The plate making/printing system according to claim 1,
wherein the code generated by the first unique code generation section and the code generated by the second unique code generation section are hash values.

5. The plate making/printing system according to claim 1, further comprising a press plate layout section for outputting, as press plate position data, information indicating where images based on each edit data are positioned on the press plate by associating the press plate with the edit data and,
wherein in the second system, the second image data is generated based on the press plate position data outputted from the press plate layout section and the edit data generated in the first system.

6. The plate making/printing system according to claim 1,
wherein the second system further includes a first image data holding portion for holding the first image data generated in the first system, and
wherein the plate inspection section identifies a first image data that is to be compared with the second image data from among the first image data held in the first image data holding portion.

7. The plate making/printing system according to claim 1,
wherein the first image data output section generates a storage portions named after a code generated by the first unique code generation section, and outputs the first image data to the data storage portion, and
wherein the plate inspection section detects, based on the code generated by the second unique code generation section, a data storage portion named after the code, and identifies a first image data stored in the detected data storage portion as a data that is to be compared with the second image data.

8. A plate inspection method for use in a plate making/printing system including a first system for generating edit data containing one or more pieces of page data written in a page-description language and first image data obtained by converting the edit data to a bitmap format and a second system for generating second image data obtained by converting the edit data generated in the first system for use in production of a press plate to the bitmap format, the method comprising:
a first unique code generation step performed in the first system for generating a unique code specific to contents of the edit data in accordance with a predetermined rule;
a first image data output step performed in the first system for outputting the first image data in association with the code generated in the first unique code generation step;
a second unique code generation step performed in the second system for generating a unique code specific to the contents of edit data generated in the first system in accordance with the predetermined rule; and
a plate inspection step performed in the second system for performing plate inspection by comparing the first image data generated in the first system with the second image data,
wherein in the plate inspection step, a first image data that is to be compared with the second image data is identified based on the code generated by the second unique code generation step.

9. The plate inspection method according to claim 8,
wherein in the first unique code generation step, a unique code specific to contents of each piece of page data contained in the edit data is further generated, and
wherein in the second unique code generation step, a unique code specific to contents of each piece of page data contained in the edit data generated in the first system is further generated.

10. The plate inspection method according to claim 8,
wherein in the first unique code generation step, a unique code specific to contents of each piece of page data contained in the edit data is generated, in place of the unique code specific to the contents of the edit data, and
wherein in the second unique code generation step, a unique code specific to contents of each piece of page data contained in the edit data generated in the first system is generated, in place of the unique code specific to the contents of the edit data generated in the first system.

11. The plate inspection method according to claim 8,
wherein the code generated in the first unique code generation step and the code generated in the second unique code generation step are hash values.

12. The plate inspection method according to claim 8, further comprising a press plate layout step for outputting, as press plate position data, information indicating where images based on each edit data are positioned on the press plate by associating the press plate with the edit data, and
wherein in the second system, the second image data is generated based on the press plate position data outputted in the press plate layout step and the edit data generated in the first system.
